(19) United States
(12) Patent Application Publication
(10) Pub. No.: US 2009/0060182 A1
(43) Pub. Date: Mar. 5, 2009

(54) Apparatus and method for enhancing the protection of media content

(76) Inventors: Thomas Killian, Westfield, NJ (US); Christopher W. Rice, Parsippany, NJ (US)

Correspondence Address: AT&T CORP., ROOM 2A207, ONE AT&T WAY, BEDMINSTER, NJ, 07921, US

(21) Appl. No.: 11/899,049

(22) Filed: Sep. 4, 2007

(51) Int. Cl. H04N 7/167; H04L 9/00

(52) U.S. Cl. 380/201; 380/217; 380/227

(57) ABSTRACT

An aspect of the current invention involves an apparatus and method for protecting media content from being read and copied by an unauthorized party. In one embodiment of the invention, this is accomplished by storing keys for decrypting encrypted media content on a secure memory device located in proximity to a computer processor. A secure memory device located in proximity to a computer processor allows for decryption keys to be sent to a user of the computer processor in advance of the user receiving an encrypted media content that will be decrypted with the decryption keys. With the secure memory device, the decryption keys can be stored indefinitely without an unauthorized party gaining access to them. Another embodiment of the invention allows for multiple media content providers to store their own decryption keys for their own encrypted media content simultaneously on a secure memory device located with a user's personal computer. A further embodiment of the invention involves using a secure memory device located with a means for displaying media content—such as a monitor or speaker—to allow for secure transfer of decrypted, decompressed media content from a computer processor used to play media content, a stand-alone media content player, or a set-top box media content player to a media content display

### BACKGROUND OF THE INVENTION

The present invention relates generally to media content, and more particularly to protecting media content. Media content, as referred to in this description, includes audio, video, or other types of content known to those in the art.

Media content providers are in a continuing “arms race” with undesired third parties, generally referred to as hackers, who, without payment, want to gain access to, and copy, proprietary digital media content. One defense against attacks by hackers involves encrypting digital media content so that the content can only be read or copied by authorized equipment or users. Such protected content is referred to herein as encrypted media content. To date, most mass-produced digital media content have been produced with some type of protection that permits the content to be read and/or copied only by those who have been so authorized. However, although prior art digital media content such as DVDs were indeed encrypted to protect the content, it was relatively easy for an unauthorized party, that is a hacker, to break the encryption and gain access to the content for viewing or copying. More recent digital media content protocols, such as Blu-Ray and HD-DVD, use strong encryption title keys, such as AES-128, which must be provided by the user to gain access to the media content—thereby protecting the encrypted media content from unauthorized access. To access these title keys, which themselves are encrypted, a digital media content player contains what is known as player keys. These player keys are credentials that enable a digital media content player to decrypt the necessary title keys and thereby decrypt the encrypted media content. Accordingly, a digital content provider can protect its encrypted media content from being read and copied by an unauthorized user by maintaining the player keys, the decrypted title keys, and the decrypted media content in secrecy.

An additional technique for protecting encrypted media content from bit-for-bit copying involves digital media content players that reveal the contents of certain “protected” sectors of the disk only to privileged software. Since these protected sectors are essential to decrypting the encrypted media content, only those in possession of the privileged software can access the encrypted media content.

The security features described above are relatively effective when media content is played on a stand-alone player or a set-top box. However, when these security features are implemented on a computer such as a personal computer, they are not as effective at providing the desired security. This shortcoming in security is due to the decentralized approach a computer takes to playing media content. Unlike the stand-alone player and set-top box, which have as their primary function the playing of digital media content, a computer supports general-purpose applications in addition to the playing of digital media content. As referred to herein, a computer which is used for playing media content usually includes at least a CPU, a program store, a read/write non-volatile memory, a digital media content reader, and graphics hardware such as a graphics card. A computer, since it performs numerous functions besides the playing of media content, involves a much more generic methodology than a stand-alone player or set-top box in that, multiple elements in a computer each participate in the playing of the media content. This approach requires the passing of critical information—such as player keys for decrypting title keys, decrypted title keys for decrypting media content and the decrypted media content itself—back and forth between different hardware elements of the computer, including the computer memory. However, hackers can easily break into the computer's memory and attempt to access the player or title keys, which would then allow them to decipher encrypted media content. For example, if a hacker breaks in and causes the computer to crash, the computer will dump its memory. By sifting through this memory dump, the hacker can try to identify critical information such as the player or title keys.

Furthermore, while a stand-alone player and a set-top box are relatively more secure than a computer with regard to the protection of keys for decryption, even these are not completely secure. This lack of complete security is related to the fact that in each of the three devices mentioned—the stand-alone player, the set-top box, and the computer—decrypted and decompressed media content is often sent to a physically separated media content display for presentation. A media content display, as referred to herein, is any means for presenting media content. An example of a media content display is a monitor and an associated speaker which are used in tandem to present audio-video content. A hacker can intercept data along this transmission link and thereby gain access to the media content. While some strategies have been implemented to try to protect the media content as it is transmitted to the media content display, such strategies have proven to be less than completely effective.

What is therefore needed is an apparatus and a method that can maintain both the keys for decrypting encrypted media content, as well as the decrypted media content itself, from being stolen by a hacker.

### SUMMARY OF THE INVENTION

In accordance with an aspect of the invention, the above problem of protecting the encrypted media content from being read and copied by a hacker is solved by using a special device to maintain the security of keys for decrypting of media content.

In one embodiment, the special device, which may be called an authorized crypto transaction processor (ACT), is used to store confidential information, such as keys for decrypting encrypted media content. Without using the ACT, such keys would otherwise be distributed on a computer platform among the disk reader, the CPU, and the graphics hardware. In a further embodiment, the ACT receives the keys from a content provider, stores the keys, and transfers the keys to another element within a computer, or to a display, only upon presentation of proper credentials.

The ACT may be a miniature system that may include a processor, a program store that may contain instructions for permitting access to stored data, such as keys, only upon presentation of proper credentials, a read/write non-volatile memory, a communication interface to the outside world such as a serial interface, a random number generator to be used in the encryption/decryption process—such as in a Diffie-Hellman exchange—and a means for deterring physical access into the ACT. The communication interface to the outside world can be used to connect the ACT, for example, to a computer or to a media content display.

The means for deterring access to the ACT may involve constructing the ACT to make it virtually impossible to gain access to its stored data without disabling it sufficiently so as to render access to the data very difficult or virtually impossible. In one embodiment, the ACT is made difficult to access by making it so small that a hacker will find it difficult to effectively tap into its circuitry. Difficulty of access to the ACT may also be enhanced by sealing the ACT, only exposing the communication interface. In another embodiment, the ACT can be manufactured to break when an attempt is made to access the interior of the ACT. Alternatively, the ACT can be manufactured so that when it breaks the non-volatile memory that is stored on it, including any keys stored in the memory or elsewhere in the ACT, is automatically erased. By combining two or more of these features, the security provided by the ACT is even further enhanced.

In a further embodiment of the ACT, it is directly attached to a secure system-on-a-chip (SOC), the SOC in turn being directly linked to a computer. An SOC, when attached to an ACT, adds to the functionality of the ACT in at least the following ways. After the proper authorization is transmitted to the ACT by the SOC, such as presenting the ACT with player keys, the SOC receives the title keys from the ACT. The SOC uses these title keys to decrypt encrypted media content. To improve the decryption step, the SOC may have an input interface with a speed of at least approximately the frame rate of the encrypted media content, such as a video. Additionally, the SOC may have an output interface with a speed of at least approximately the pixel rate of the decrypted, uncompressed media content.

There are at least three exemplary embodiments of the ACT-SOC system: (1) directly attaching the ACT to the SOC and directly connecting the SOC to a computer (as just mentioned), (2) directly attaching the ACT to the media content display and directly connecting the SOC to a computer, set top box or stand alone player, or (3) directly attaching the ACT to the SOC and directly attaching the SOC to a media content display. The second and third embodiments address a specific weak link in the provision of proprietary media content—the transfer of content from the computer, set-top box or stand-alone player to the media display.

Currently, when the media content is decrypted and uncompressed within a computer, a set-top box, or a stand-alone player, the decrypted and uncompressed media content is transferred to the display using HDMI—a standard that is used to transmit data between the player and the display. HDCP is the encryption protocol used for transferring this uncompressed media content from the player to the display. Unfortunately, HDCP is not as secure as is needed for insuring secure transfer of the encrypted media content to the display. The media content encrypted with this weak encryption protocol can be intercepted and decrypted without much difficulty. Therefore, the second and third of the exemplary embodiments—directly attaching the ACT to the media content display while the SOC is directly linked with the computer, or directly attaching the ACT to the SOC and directly attaching the SOC to the media content display—are advantageous because they allow for the media content to be more securely sent to the media content display.

The second embodiment of the ACT and SOC system involves the SOC being directly linked within a computer, set-top box, or stand-alone player, while the ACT is in communication with the SOC, but is directly attached to the means for displaying the media content, such as a monitor for displaying media content. In the third embodiment, the ACT can be directly attached to the SOC while the SOC is directly attached to the means for displaying the media content. What both of these embodiments address is the weak link in the transfer of decrypted media content from a media content player to a media content display. Each of these embodiments enables the transmission of strongly encrypted or re-encrypted media content to the media content display—where it is securely decrypted by the powerful ACT-SOC system—thereby more effectively protecting the media content during its transmission from the computer, set-top box or stand-alone player to the media content display.

A further embodiment of the invention involves revoking the keys as a function of the customer's business relationship with the encrypted media content providers or other providers of keys. Each media content provider, when authorized by the customer, can store encryption information on the customer's ACT. When the customer or the provider wants to discontinue the business relationship, either can end the relationship, for example, by removing the keys for decryption from the user's ACT.

Some specific aspects of this embodiment are now introduced. First, multiple providers can have their title keys stored simultaneously within the ACT. Currently set-top boxes are given to a user by a single provider, and only that provider is able to store its title keys on the set-top box. Second, with the ACT able to maintain the security of the title keys stored on it—whether encrypted or decrypted—even over extended periods of time, the sending of the title keys can be decoupled from the sending of the encrypted media content. The title keys can even be sent to the user's media content player or users media content display well in advance of the user receiving the encrypted media content. Also, the title keys can be held securely on the ACT and used multiple times. This gives added flexibility to the business relationship that can be established between the user and the media content provider. These options of sending the keys well in advance of the user playing the media content and keeping the keys for multiple uses are risky options with current computer processor models because, currently, the computer has no place to securely store the title keys. Therefore, currently the media content provider most often sends the keys as close as possible in time to the user's playing of the media content in order to minimize the length of time during which the title keys—once decrypted—are in the computer's memory. Likewise, in current systems, soon after the media content is decrypted with the decrypted title keys, these title keys are ideally erased in order to avoid a hacker from getting access to them. As explained, the current invention enables separating in time the transmission of the keys from the transmission of the media content.

These and other advantages of the invention will be apparent to those of ordinary skill in the art by reference to the following detailed description and the accompanying drawings.

### BRIEF DESCRIPTION OF THE DRAWINGS

FIG. 1 is a schematic representation of a stand-alone player system for playing encrypted media content.

FIG. 2 illustrates transmission of encrypted media content over a network.

FIG. 3 illustrates transmission of encrypted media content over a network to a media content player integrated into a computer.

FIG. 4 illustrates transmission of encrypted media content over a network to a set-top box with a media content player and media content display.

FIG. 5 is a schematic representation of a system-on-a-chip (SOC) and an authorized crypto transaction processor (ACT) for making a computer into a secure device for playing encrypted media content.

FIG. 6 is a schematic representation of how an SOC and an ACT can make a computer and a display of media content linked to the computer into secure devices for playing encrypted media content.

FIG. 7 is a schematic representation of a stand-alone player that incorporates an ACT with the display.

FIG. 8 illustrates transmission of encrypted media content over a network to a set-top box with a media content player and media content display that incorporates an ACT with the display.

FIG. 9 is a flowchart illustrating the transfer of encrypted media content from a media content provider to a user of a computer.

FIG. 10 is a flowchart illustrating the transfer of encrypted media content from a media content provider to a user of a computer using an ACT.

### DETAILED DESCRIPTION

Providers of proprietary digital media content need to guard the rights of their media content and prevent it from being freely copied. Therefore, such providers seek a way to limit those who can read the media content and even further to limit those who can copy the media content. While these goals are shared by most providers of mass-produced digital media content, achieving these goals has proven to be quite elusive. One strategy has been to encrypt the media content, thus rendering it unreadable and/or uncopyable without the appropriate “keys” for decryption. A key is defined herein as a piece of metadata that is needed to decrypt an encrypted piece of data into a form that is readable without further decryption. By encrypting the media content, a third-party such as a media content provider can control and limit access to the media content. Access is granted to a user by giving the user the needed keys for decryption.

Recently there has been an effort to formalize the use of keys in protecting multimedia content. This has been initiated by a consortium known as the Advanced Access Content System Licensing Administrator, LLC (AACS LA). This consortium created a standard for content distribution called Advanced Access Content System (AACS), which calls for transmitting media content in encrypted form and for transmitting what are referred to as title keys—also in encrypted form—that the user receives in order to decrypt the encrypted media content. The title keys are decrypted with what are referred to as player keys, which are often stored on a user's device prior to the issuing of the title keys. Player keys may even be stored on a user's device from the time of manufacture of the device. Once the title keys are decrypted by the player keys, a user can use the title keys to decrypt the encrypted media content.

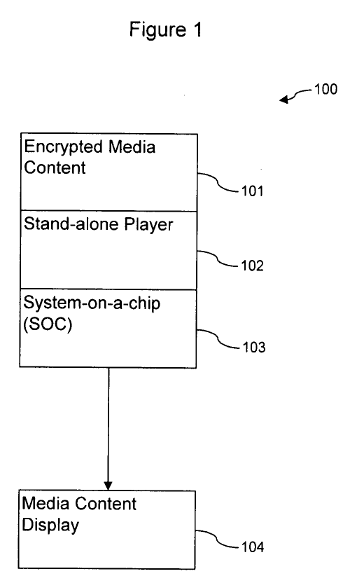

In FIG. 1, at 100, a stand-alone player system is shown schematically. In this system, the stand-alone player, 102, can play non-encrypted media content as well as decrypt and play encrypted media content, 101. A stand-alone player that is used for playing encrypted media content contains player keys for decrypting title keys which can then be used to decrypt the encrypted media content. Alternative embodiments include providing the user with encrypted media content via a hard storage disk or a network. In one embodiment, the decryption means may be a system-on-a-chip, called an SOC 103. Media content is often compressed as well as encrypted. Therefore, when the media content is decrypted, it may also be decompressed. Once the media content is decrypted and decompressed, it is suitable to be played on an exemplary media content display, 104. If the media content contains audio-visual content, the display would include a means for playing sound and picture, such as speakers and a monitor.

A weak link in the process of securely playing media content on any device involves the process of displaying the media content after it has gone through the process of being decompressed and decrypted. If the media content is sent to a display 104 without any encryption, then a hacker might be able to intercept the decompressed and decrypted media content as it is transmitted from the player to the media content display. If there is no gap between the two pieces of equipment and they are attached to one another, then it is more difficult for the hacker to intercept the transmitted media content. (When two pieces of equipment are referred to in this specification as being “attached”, the intended meaning is that they are physically bonded so tightly as to make if very difficult if not impossible for a hacker to obtain the data that is being communicated between the two pieces of equipment. Accordingly, “attaching” two devices allow the devices to communicate with each other without having to use a cryptographic protocol for security. In this context, a computer—with so many disparate elements—usually does not have elements “attached” to it, rather elements are “linked” to or within the computer.) If a cable is used to transmit the media content to the display, the hacker may intercept the transmission of the decompressed, decrypted media content before it arrives at the display.

In an attempt to minimize the risk of a hacker stealing this media content as it is sent to the display, the industry has created a standard for transmitting to a display called High-Definition Multimedia content Interface (HDMI). The HDMI standard dictates, for example, what kind of cables and transmission rates to use. A protocol called High-bandwidth Digital Content Protection (HDCP) re-encrypts the decrypted, decompressed media content. This allows for the secure transmission of the media content to the media content display, such as a monitor, over unsecured cables, using the HDMI standard. HDMI/HDCP monitors have special dedicated hardware to decrypt the encrypted raw video. The goal of using the HDCP protocol to re-encrypt the decrypted, decompressed media content is to protect such content during transmission, subsequent to the initial decryption and decompression. Unfortunately, the HDCP protocol has proven to be weak, thus giving hackers an opportunity to decrypt the re-encrypted, uncompressed media content.

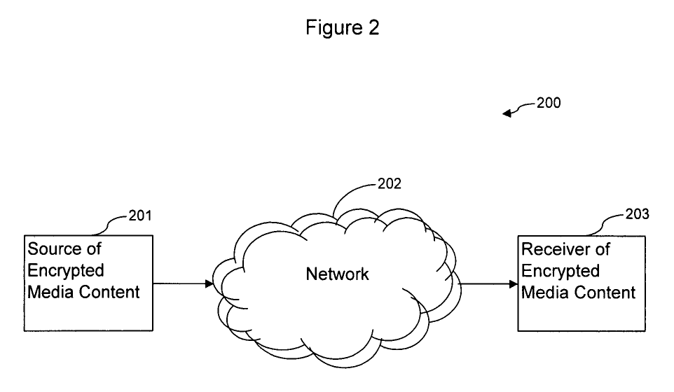

In FIG. 2, at 200, there is shown a schematic representation of a generic system for transferring encrypted media content over a network. In one embodiment, a user requests the transfer of the encrypted media content. In a second embodiment, the provider of the encrypted media content chooses to initiate the transmission of the media content, even without the prompting of the user. In these and other possible embodiments, the encrypted media content may be sent by a media content provider, 201. The encrypted media content and/or an encrypted title key are sent over a network, 202, to a user, 203. The user receives the encrypted media content that is transmitted over the network. In one embodiment, the network used for sending the encrypted media content includes the Internet. The media content provider may send the media content based on the user's inputs on a webpage.

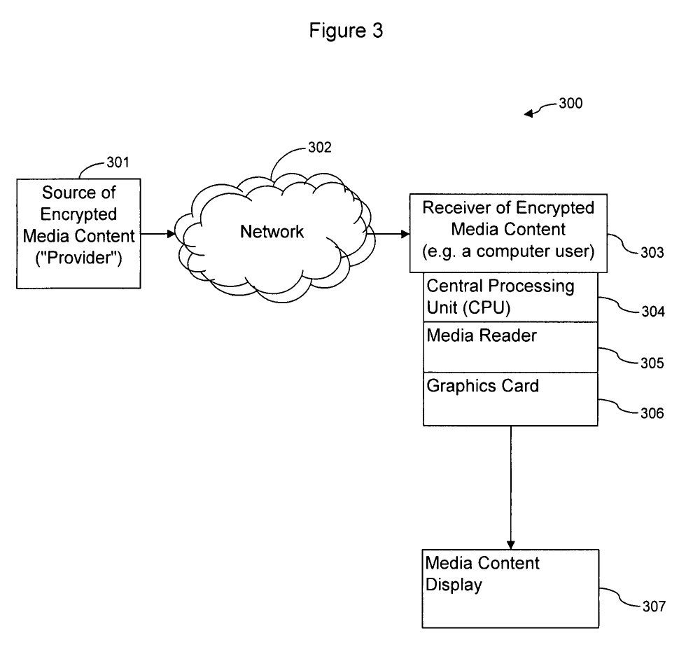

FIG. 3, at 300, is a schematic representation of an embodiment of the system shown in FIG. 2. A provider of encrypted media content, 301, is shown. This provider sends encrypted media content and/or encrypted title keys over a network, 302, to a user of a computer, 303, such as a personal computer. The computer contains various pieces of hardware that facilitate the decrypting and playing of the encrypted media content. In one embodiment, three pieces of equipment that a computer may use to decrypt encrypted media content are a central processing unit (CPU) 304, a media content reader 305, and a graphics card 306. In this specification, the term “reader” refers to a device which extracts data from a medium for further processing. This is in contrast to “player” which refers to a device dedicated to playing content from a medium. The reason why a computer may use multiple pieces of general hardware in order to play encrypted media content—instead of one piece of dedicated hardware as is common in a stand-alone player—is because a computer simultaneously supports many other functions besides the playing of digital media content. The computer utilizes a combination of various general hardware to perform most of its functions, of which playing digital media content is just one such function.

Unfortunately, using a computer to securely play encrypted media content has proven to be challenging. One disadvantage is that by utilizing multiple pieces of hardware in order to play media content, the secure information such as player keys, title keys and decrypted media content can potentially be accessed by a hacker as the information flows from one piece of hardware to another. Additionally, even the security of merely storing—as opposed to transmitting—confidential data is suspect. For example, player keys can be stored inside the player program code image and obfuscated in some way. However, such a storage method is also susceptible to hackers, allowing the hackers to access the player keys. Even worse is the security of title keys. There is no secure area in the computer to store the transmitted title keys. There is some security in that the title keys are encrypted when they are sent from the media content provider. However, even encrypted title keys have value to a hacker in that the keys will function for any user with a working player, since that player has player keys that can decrypt the encrypted title keys.

Due to these disadvantages, media content providers usually try to send keys for decrypting the media content at the last possible moment, immediately before the user of the computer will need the keys to decrypt the encrypted media content. In a scenario when encrypted media content is transmitted to a user, the media content provider will make sure that either the encrypted title key is sent sometime after the user is anticipated to have received the encrypted media content, or that the transfer of encrypted title keys is somehow “coupled” with the transfer of the encrypted media content. An example of “coupling” includes coordinating some or all of the following: transferring both the media content and title keys (1) in one network session, (2) from one website, and/or (3) at a similar time. Additionally, the key is usually erased immediately after the media content is decrypted and subsequently played. By minimizing the time that the keys are stored on, and used by, the computer, the media content provider hopes to limit the likelihood that the keys will be stolen. However, this approach obviously does not guarantee the security of the media content.

Another strategy that a hacker may implement to extract the keys used for decrypting the media content is to cause the computer to crash. After crashing, the hacker can intercept the subsequent memory dump. By reading the data in the memory, the hacker may be able to find the keys for decryption.

As mentioned previously in the description of FIG. 1, media content is often transmitted both compressed and encrypted. Therefore, decryption of the media content is often accompanied by decompression. Accordingly, another weak link in the process of securely playing a piece of media content involves the process of sending the media content to a display after the media content has gone through the process of being decrypted and decompressed. As in FIG. 1, this issue has been addressed by the industry. A standard for transmitting to the display has been created which is called High-Definition Multimedia content Interface (HDMI). A protocol called High-bandwidth Digital Content Protection (HDCP) utilizes the HDMI standard to re-encrypt the decompressed and decrypted media content. This protocol is intended to protect the media content it as is transmitted in uncompressed form to the display. Unfortunately, as mentioned previously, the HDCP protocol has proven to be weak, and, at times, hackers have been able to decrypt the re-encrypted, uncompressed media content.

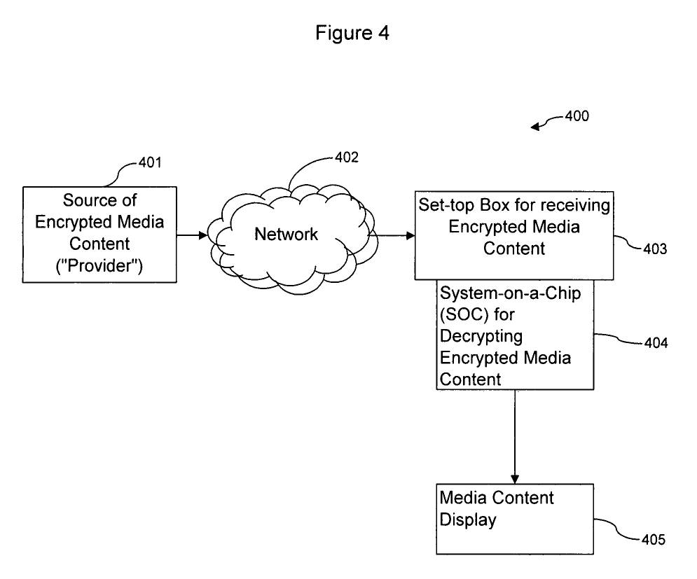

In FIG. 4, at 400, a set-top box system is shown schematically. A set-top box, 403, is a device that may receive media content, for example, via transmission by a media content provider, 401, over a network, 402. This media content is usually sent in encrypted, compressed form together with an encrypted title key. The set-top box receives the encrypted, compressed media content and encrypted title key. Utilizing a player key that was likely stored in the set-top box sometime before it was delivered to the user, the title key is decrypted. Once the title key is available in decrypted form, it is used to decrypt the encrypted media content and then decompress it. This decryption and decompression may be done by a system-on-a-chip (SOC), 404. The decrypted, decompressed media content is then sent to a media content display 405 utilizing the HDMI standard and the HDCP protocol, as mentioned previously, and as shown, for example, in FIGS. 1 and 3.

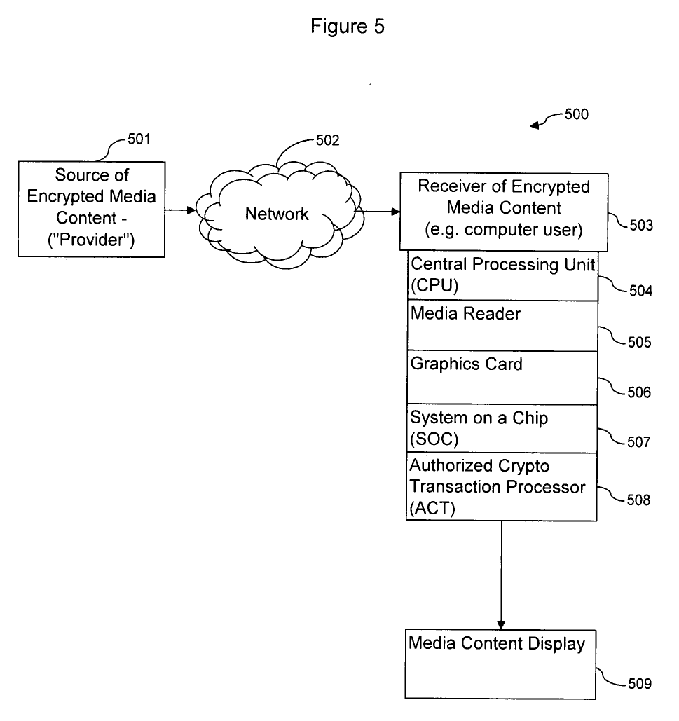

In FIG. 5, at 500, an improved system for protecting digital media content from being hacked is shown schematically. A provider of encrypted media content, 501, sends the media content over a network 502 to a user's computer 503. As in FIG. 3, the computer contains different pieces of hardware that allows it to decrypt, decompress, and play the media content for a user. In one embodiment, three pieces of equipment that the computer uses are a central processing unit (CPU) 504, a media content reader 505, and a graphics card 506.

In order to provide additional security features to protect content from unauthorized reading and copying, two further pieces of hardware are incorporated into the computer in accordance with one aspect of the present invention. First, an SOC, 507, is utilized. In one embodiment, the SOC is linked to the computer by means of a graphics card, 506. The SOC is used to decrypt and decompress the media content by using title keys for decryption that may be stored securely on an authorized crypto transaction processor (ACT) 508. The player keys for decrypting the title keys may be stored, for example, in the SOC or the ACT. In order to efficiently and rapidly decrypt and decompress the content, the SOC may have an input interface with a speed of at least approximately the frame rate of the encrypted media content, such as a video. Additionally, the SOC may have an output interface with a speed of at least approximately the pixel rate of the decrypted, uncompressed media content.

The SOC also participates in the delivery of the decrypted media content to a secure display device. In this way, the computer's CPU can be “un-trusted”, meaning that the CPU never handles either decrypted keys used for decryption, or decrypted, decompressed media content. Rather, the CPU only sees encrypted keys and encrypted media content.

As just mentioned, the SOC is in communication with an ACT. The ACT may be a miniature system with a processor, a program store, read/write non-volatile memory, a communication interface, communication means using a secure cryptographic protocol, a random number generator, and a means for deterring physical access to the device. The ACT stores at least one title or player key for decryption. The program store includes instructions for permitting access to data—such as title or player keys—stored on the ACT when proper credentials are presented. Additionally, the program store may include a program for controlling who gets to store and erase title keys as well as who gets access to information about business relationships between the user and content providers. “Proper credentials” in this context could mean presenting proper RSA keys or presenting symmetric player keys as defined by the AACS.

By using the SOC and ACT combination, the problems of transmitting sensitive data, such as media content, between various pieces of hardware on the computer is mitigated. The decrypted keys and media content are kept secure within the SOC and ACT combination. Another benefit of the high security of the SOC and ACT combination is that there is no time restriction for when the keys for decryption are sent to the ACT by the media content provider. For example, the encrypted player keys can be transmitted by a media content provider before transmitting the encrypted media content (1) in an earlier network session and/or (2) from a different website. Likewise, there is no need for the ACT to immediately erase the keys after the keys are used to decrypt the encrypted piece of media content.

In one embodiment, the SOC and ACT are “attached” to one another. This allows player keys and title keys to be passed freely and securely between the SOC and the ACT. In another embodiment, the SOC and ACT are “linked” to each other—although not necessarily “attached” to one another. Since, in the latter embodiment, communication between the SOC and ACT could be tapped by a hacker, a secure communications channel needs to be established. For example, the SOC and ACT can use a signed Diffie-Hellman exchange to agree on an AES-128 key that will be used to encrypt the data passed between them. To verify the signatures in the Diffie-Hellman exchange, the SOC and ACT must be provisioned with each other's public keys. This can be accomplished by providing the SOC and ACT each with the other's X.509 certificate that has been signed by a trusted third party such as a manufacturer or industry alliance; the public key of the trusted third party is incorporated into the SOC and ACT at the time of manufacture. The well-known SSL protocol uses the techniques outlined here. The channel so-established allows the player and title keys to be exchanged securely between the SOC and ACT.

In one embodiment, a player key is stored in the SOC and an encrypted title key is stored on the ACT. In this embodiment, the decryption of the title key takes place in the SOC. The decrypted title key is used by the SOC to decrypt the encrypted media content. In another embodiment, a player key is stored in the ACT. In this embodiment, the decryption of the encrypted title key takes place in the ACT. The decrypted title key is transferred from the ACT to the SOC and the SOC uses the decrypted title key to decrypt the encrypted media content.

By storing the title key on the ACT and the player key on the ACT or the SOC, the keys and the subsequently decrypted media content can be maintained securely within the computer environment. This security was not possible in the computer environment previous to this invention because a typical computer doesn't have a secure location to store these sensitive data.

A security feature of the ACT (and/or the ACT and SOC combination) is that it is extremely difficult for a hacker to gain access to its memory. First, the size of the ACT (and/or the ACT and SOC combination) is small enough to make it difficult for a hacker to effectively tap into its circuitry. Second, the ACT can be sealed with only a serial port being projected outside of the sealing. This limited access contributes to making it difficult to access the inner workings and memory of the ACT. Third, even if a hacker tries to open up the ACT for better access to its circuitry, a computer chip inside the ACT can be programmed to automatically “self-destruct”, i.e. erase critical information stored in the ACT such as keys, when it senses that its casing is being breeched. Other methods for detecting tampering are known to those of skill in the art. By utilizing the SOC and the ACT to store encrypted and decrypted keys and media content, an ordinary computer is transformed into a secure, trusted device for processing and playing media content.

As was described previously by FIGS. 1, 3 and 4, the decompressed, decrypted media content may be transmitted to the display 509 with the HDMI standard utilizing the HDCP protocol.

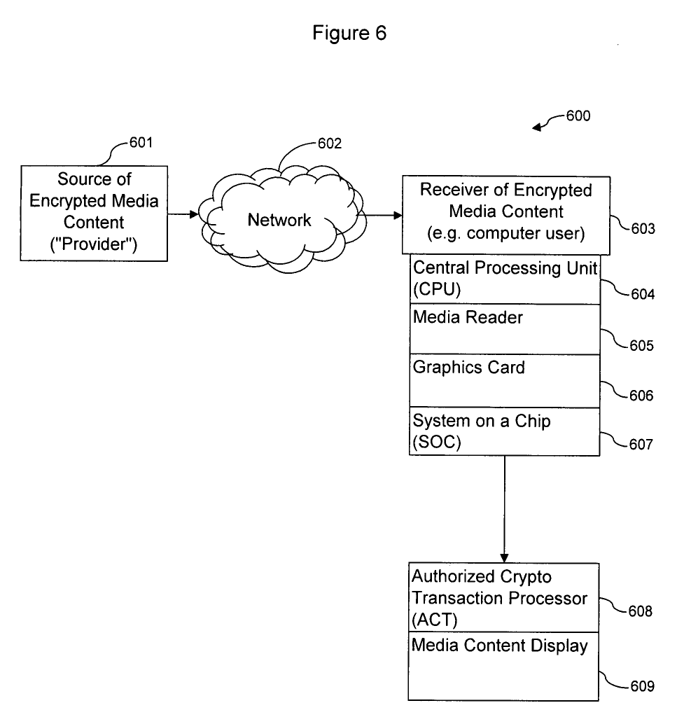

In FIG. 6, at 600, an alternative embodiment of FIG. 5 is shown. While 601-607 mimic 501-507, the difference between the two embodiments can immediately be seen by noting where the ACT, 608, is located. In FIG. 5, the ACT 508 was attached directly to the SOC which itself was linked directly to a computer. The decompressed, decrypted media content was transmitted to the display using the HDMI standard and the HDCP protocol. As mentioned in connection with FIG. 3, the HDCP protocol has proven to be a weak re-encryption protocol. The embodiment of FIG. 6 is one way to solve this problem. FIG. 6 shows the ACT located in proximity to a media content display, 609. The HDMI standard is utilized, like in FIG. 3. Additionally, the HDMI/HDCP media display still has special dedicated hardware for decrypting the encrypted raw media content, such as a monitor utilizing dedicated hardware in order to decrypt encrypted video. However, locating the ACT with the media content display allows for the ACT and SOC to mitigate the weaknesses of the HDCP protocol. HDCP protects video data by forming an “exclusive-or” of the video bit stream with a pseudo-random bit stream generated by special hardware at each end of the HDCP connection; before data can flow, these two pieces of hardware must be synchronized so that they generate identical pseudo-random streams. (“Exclusive-or” is a logic function of two input bits; it is equal to zero if the bits are the same, and equal to one if they are different.) HDCP specifies how the ends of the connection should authenticate each other and agree on keying material to synchronize their hardware—but the specified mechanism is very weak, being predicated on an assumed paucity of computational resources available in the media content display. The ACT can improve on HDCP by doing strong authentication, (e.g. using RSA keys), between the SOC and the media content display and by assisting in the generation and secure exchange of keying material without otherwise processing the video stream. Therefore, the decompressed, decrypted media content can be securely sent from the SOC, located and linked with the computer, to the media content display, which is directly attached to the ACT. Another SOC may be attached to the ACT, both being located with the media content display, to participate in the further decryption of the content.

In this figure, as in one of the embodiments of FIG. 5, the SOC and ACT establish a secure communications channel using something like a signed Diffie-Hellman exchange. Both the SOC and ACT have certificates or at least RSA keys. This channel allows the player and title keys to be exchanged securely between the SOC and ACT.

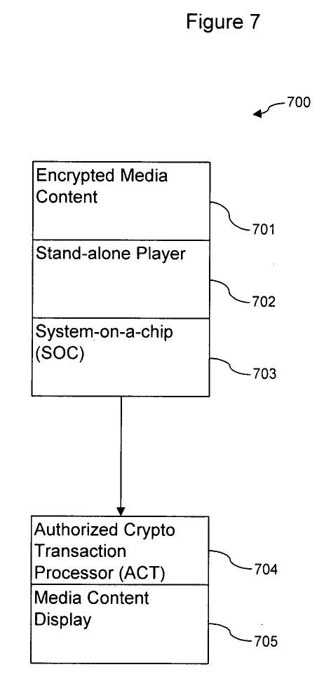

In FIG. 7, at 700, a stand-alone player 702 is shown that provides a higher degree of protection than the stand-alone player shown in FIG. 1. In this system, the player can play non-encrypted media content as well as decrypt and play encrypted media content, 701. As in FIG. 1, the stand-alone player incorporates a SOC, 703—or something functionally similar to an SOC—for management of the keys used to decrypt the encrypted media content. The SOC can then buffer the decrypted media content before it is transmitted to a media content display. Instead of using the weak HDCP protocol to transmit decrypted, decompressed media content, as was shown in FIG. 1, FIG. 7 shows an embodiment similar to FIG. 6. As in FIG. 6, the issue of securely transmitting the decompressed, decrypted media content is addressed by locating an ACT, 703, with the media content display, 704. The ACT and the SOC agree to a secure re-encryption protocol, allowing the decompressed, decrypted media content to be transmitted securely. Here, as in FIG. 6, another SOC may be attached to the media display to participate in the further decryption of the content.

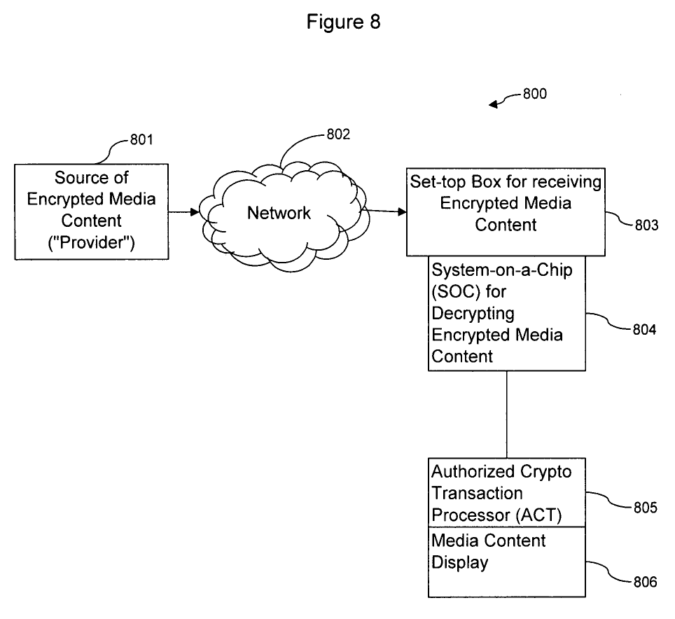

In FIG. 8, at 800, a set-top box system is shown that provides a higher degree of protection than the set-top box system shown in FIG. 4. As in FIG. 4, the set-top box, 803, may receive encrypted media content and encrypted title keys from a media content provider, 801, over a network, 802, such as the Internet. The encrypted media content may also be delivered to the user's set-top box utilizing other methods, such as delivering a copy of the encrypted media content on a memory device such as a CD, DVD or hard drive. Also similar to FIG. 4, the encrypted media content is decrypted and decompressed by a SOC, 804. The SOC stores the media content until it is transmitted to a media content display. However, instead of utilizing the HDCP protocol over the HDMI standard to transmit the media content, or in addition to that, the decompressed, decrypted media content is transmitted to the media content display utilizing an ACT, 805, located in proximity to the media content display, 806. As in FIGS. 6 and 7, the ACT and the SOC agree on a secure protocol for re-encrypting the media content so that it can be securely delivered to and played on a media content display. Here, as in FIG. 6, another SOC may be attached to the media display to participate in the further decryption of the content.

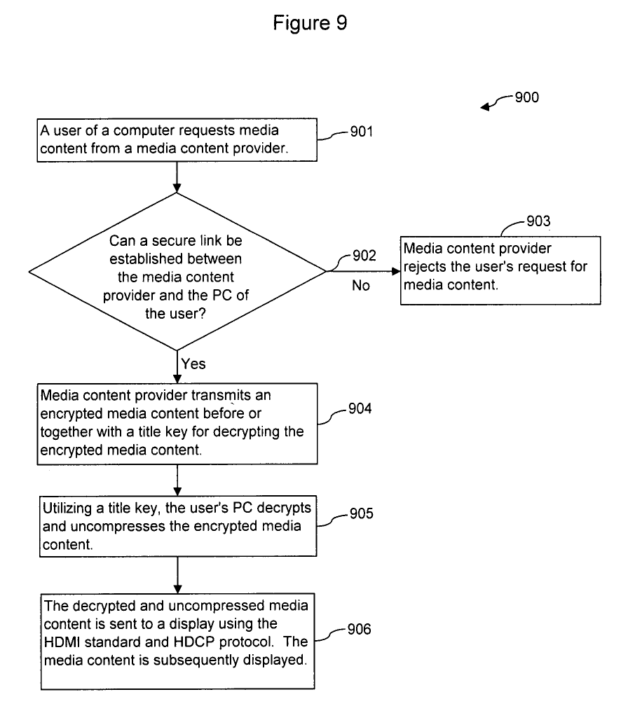

In FIG. 9, at 900, there is disclosed a flowchart that illustrates a method for transferring encrypted media content from a media content provider to a user of a computer without the use of the current invention. Beginning at step 901, a user of a computer requests the transfer of encrypted media content from a media content provider. In a separate embodiment, the media content is sent by the media content provider without the user first requesting the transfer of the media content. Other embodiments that involve alternative techniques for initiating transmission of media content can be envisioned by one of ordinary skill in the art. At step 902, in one embodiment, it is determined if a secure link can be established between the media content provider and a computer of the user. This may be accomplished by using a secure HTTP crypto challenge administered by the encrypted media content provider. If the computer does not pass this challenge, then, at step 903, the encrypted media content provider rejects the request for transfer of encrypted media content and/or encrypted title keys for decrypting the encrypted media content. There are various reasons why it is desirable that the link between the media content provider and the user be secure. Some examples are: (1) to authenticate the user/purchaser and perhaps transfer billing information, (2) to assure the user that the content is genuine, and (3) to protect the provider against an eavesdropper who may have hacked player keys. If the computer passes this challenge, then, at step 904, these data are transferred to the user's computer.

At 904, the media content provider transmits encrypted media content before or together with an encrypted title key. Once the encrypted title key is decrypted by a player key, the title key is used for decrypting the encrypted media content. As was described in FIG. 3, it is advantageous in this computer model to send the keys for decryption at the latest possible moment such that they are received just at the time when they are needed. Similarly, as soon as such keys are used to decrypt the media content, the keys are erased. This protocol is needed as a security measure to try to limit the amount of time that a hacker can try to gain access to these keys, since it is difficult for the computer to securely store these keys, especially the player key and the title key after it has been decrypted.

At step 905, the user's computer utilizes the keys for decryption to decrypt and uncompress the encrypted media content. Once the encrypted media content is decompressed, at step 906, it is sent to a display using the HDMI standard and HDCP protocol. The media content is subsequently displayed.

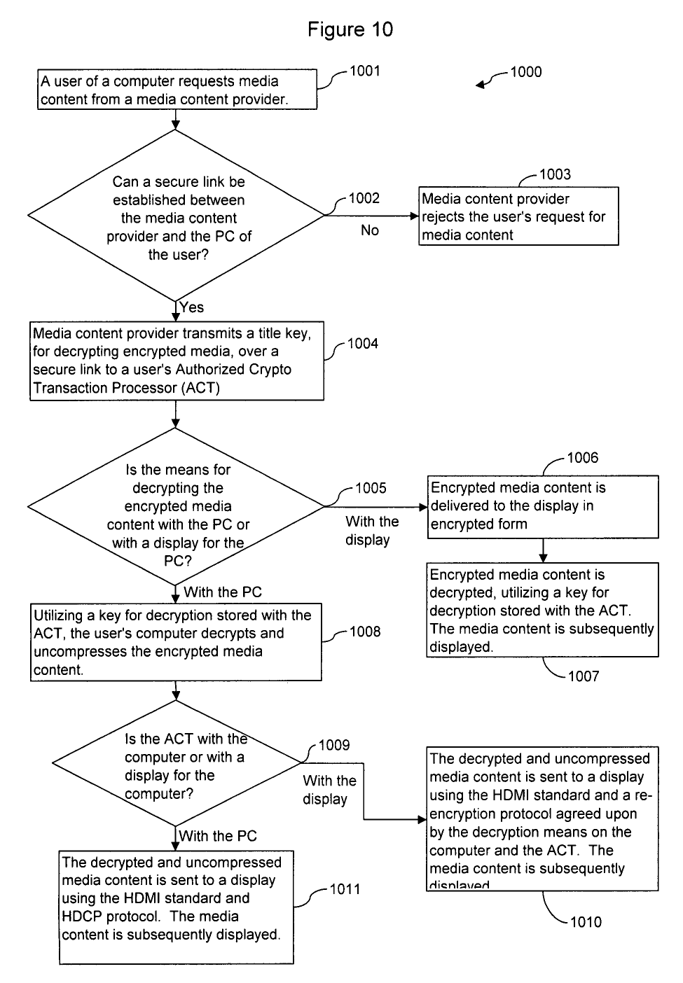

In FIG. 10, at 1000, there is disclosed a method for transferring encrypted media content from a media content provider to a user of a computer, in accordance with one aspect of this invention utilizing an ACT to provide an additional level of security to the encrypted media content. The first three steps in FIG. 10, 1001-1003 are equivalent to steps 901-903 in FIG. 9. However, at step 1004, the media content provider transmits an encrypted title key to an ACT for decryption of encrypted media content.

This transmission may take place by means of a secure link to an ACT of the user. Unlike previous embodiments for transferring encrypted media content and an encrypted title key for decrypting the encrypted media content, in this embodiment it is equally acceptable to send the encrypted title keys for decryption well in advance of needing such keys as to send the keys when needed. As was described in FIG. 3, it was advantageous in the typical computer model to send the keys for decryption at the latest possible moment such that they area received just at the time when they are needed. Similarly, as soon as such keys are used to decrypt the media content, the keys are erased. That protocol is needed as a security measure to try to limit the amount of time that a hacker can try to gain access to these keys. However, when an ACT is utilized, as is described in FIG. 5, these keys can be maintained securely for any period of time. Therefore, there is no need to limit the amount of time that the user is in possession of such keys.

Another aspect of the current invention is that multiple media content providers can simultaneously store their keys for decryption on an ACT. The user of a computer can establish several agreements with different media content providers to receive keys and encrypted media content from each provider, regardless of the existence of similar relationships with other media content providers. Additionally, these relationships can be established or discontinued by either the computer user or the media content provider.

As the process continues, at step 1005, it is determined if a means for decrypting the encrypted media content is located in proximity to a computer or to a media content display. An example of a means for decrypting encrypted media content is a system-on-a-chip (SOC). Other examples of such means can be envisioned by one of ordinary skill in the art.

If the means for decryption is located with the media content display, then, at step 1006, encrypted media content is delivered to the display in encrypted form. Once the encrypted media content is received at the display, at 1007, a title key—decrypted by means of a player key—is utilized to decrypt the encrypted media content. Once the media content is decrypted and decompressed, it displayed on the media content display.

If the means for decryption is linked directly to the computer of the user, then, at step 1008, media content is delivered to the computer in encrypted form. The computer then accesses the ACT in order to utilize the appropriate title key—decrypted by a player key—in order to then decrypt and decompress the encrypted media content.

If it is determined that the ACT is linked directly to the computer, then at step 1011, the encrypted media content is decrypted and decompressed at the computer. For example, the encrypted media content may be decrypted by a video logic block that is part of the ACT/SOC system. This video logic block would be attached to the ACT/SOC system's processor. The video logic block is dedicated to decrypting, uncompressing, and re-encrypting the media content. Also attached to the video logic block are an input interface and output interface for receiving and sending out the media content, respectively. The input interface has a speed of transmission of at least approximately the frame rate of the encrypted compressed video; the output interface has a speed of transmission of at least approximately the pixel rate of the raw video. Subsequently, the decrypted, decompressed media content is sent to a display using the HDMI standard and HDCP protocol. As mentioned previously in the description of FIG. 1, this approach is not completely secure due to the weakness of the HDCP protocol. The media content is subsequently displayed.

However, if it is determined that the ACT is attached directly to the media content display, then, at step 1010, the decrypted and uncompressed media content is sent to the display using the HDMI standard and a re-encryption protocol agreed upon by the decryption means on the computer—such as an SOC—and the ACT. By utilizing this re-encryption protocol, a secure transfer can be established between the computer and the media content display. This secure transfer solves the problem mentioned just previously regarding step 1011. The media content is subsequently displayed on the media content display.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A device for participating in the decryption of encrypted media content comprising:
a processor;
a program store connected to the processor;
a read/write non-volatile memory connected to the processor;
a communication interface connected to the processor;
a random number generator connected to the processor; and
means for deterring access to information stored on the device.

2. The device of claim 1 further comprising information stored on the program store for permitting access to data upon the presentation of proper credentials.

3. The device of claim 1, further comprising a media content display to which the device is attached.

4. The device of claim 3, further comprising stored information to enable communication using a secure cryptographic protocol.

5. The device of claim 4, further comprising:
means for transferring said encrypted media content, after it is decrypted, to a media content display device using a High-Definition Multimedia content Interface (HDMI) standard.

6. The device of claim 6, wherein said secure encryption protocol is agreed upon by the device and a second device, said second device used for re-encrypting media content.

7. The device of claim 6, wherein said second device is a system-on-a-chip.

8. The device of claim 1, further comprising: a volatile working storage connected to the processor.

9. The device of claim 1, wherein the program store comprises a read only memory.

10. The device of claim 2, wherein said data is a title key used for decrypting encrypted media content.

11. The device of claim 10, wherein the title key is transmitted to the device in a different, earlier network session than the session in which the encrypted media content is transmitted.

12. The device of claim 2, wherein said data comprises a plurality of title keys.

13. The device of claim 12 wherein at least two of the said title keys are associated with different media content providers.

14. The device of claim 2, wherein said data comprises a player key.

15. The device of claim 2, wherein said data comprises a plurality of player keys.

16. The device of claim 2, wherein said data is stored in the read/write non-volatile memory.

17. The device of claim 1, wherein said means for deterring access to information stored on the device includes means for destroying at least a portion of the read/write non-volatile memory when an attempt is made to access said memory.

18. The device of claim 1, wherein said means for deterring access to information stored on the device comprises a physical enclosure which limits access to said communication interface.

19. A device for participating in the decryption of encrypted media content comprising:
a processor;
a program store connected to the processor;
a read/write non-volatile memory connected to the processor;
a communication interface connected to the processor;
a random number generator connected to the processor;
means for deterring access to information stored on the device; and
means for decrypting and uncompressing an encrypted media content.

20. The device of claim 19, wherein said encrypted media content is an encrypted video stream.

21. The device of claim 20, wherein said means for decrypting and uncompressing an encrypted video stream comprise:
an output interface connected to the processor with a speed of at least approximately the pixel rate of the raw video; and,
an input interface connected to the processor with a speed of at least approximately the frame rate of the encrypted compressed video.

22. The device of claim 21, wherein said means for decrypting and uncompressing an encrypted video stream are:
a video logic block connected to the processor;
an output interface connected to the video logic block with a speed of at least approximately the pixel rate of the raw video; and,
an input interface connected to the video logic block with a speed of at least approximately the frame rate of the encrypted compressed video.

23. The device of claim 22, wherein the device is linked directly to a computer.

24. The device of claim 23, wherein the device is attached directly to a media content display.

25. A method for transmitting encrypted media content comprising:
transmitting an encrypted title key to a device, said encrypted title key capable of being used to decrypt an encrypted media content,
thereafter, in a different media session, transmitting said encrypted media content requested by a user.
